(19) United States
(12) Patent Application Publication
(10) Pub. No.: US 2001/0036968 A1
(43) Pub. Date: Nov. 1, 2001

(54) Process for preparing monodisperse cation-exchanger gels

(76) Inventors: Claudia Schmid, Leichlingen (DE); Wolfgang Podszun, Koln (DE); Rudiger Seidel, Leverkusen (DE); Olaf Halle, Koln (DE); Ralf-Jurgen Born, Langenfeld (DE); Reinhold Klipper, Koln (DE)

Correspondence Address: BAYER CORPORATION, PATENT DEPARTMENT, 100 BAYER ROAD, PITTSBURGH, PA, 15205, US

(21) Appl. No.: 09/836,772

(22) Filed: Apr. 17, 2001

(30) Foreign Application Priority Data
Apr. 17, 2000 (DE) 10020534.8

(51) Int. Cl. C08J 5/20

(52) U.S. Cl. 521/25

(57) ABSTRACT

The invention relates to a process for preparing monodisperse cation-exchanger gels with increased oxidation resistance and with high osmotic stability and purity by

(a) polymerizing monodisperse microencapsulated monomer droplets made from a monomer mixture (1) comprising from 90.5 to 97.99% by weight of styrene, from 2 to 7% by weight of divinylbenzene, and from 0.01 to 2.5% by weight of free-radical generator in aqueous suspension to conversions of from 76 to 100%,

(b) adding a monomer mixture (2) made from 70.5 to 95.99% by weight of styrene, from 4 to 15% by weight of divinylbenzene, from 0 to 12% by weight of a third comonomer, and from 0.01 to 2.5% by weight of one or more free-radical generators to form a copolymer, wherein a portion of from 50 to 100% by weight of the monomer mixture (2) is added under polymerization conditions in which at least one free-radical generator from monomer mixture (2) is active, and

(c) functionalizing the reaction product from process step (b) by sulfonation.

### BACKGROUND OF THE INVENTION

The invention relates to a process for preparing monodisperse cation-exchanger gels with high oxidation resistance and also with high osmotic stability and purity.

In recent times increasing importance has been placed on ion exchangers with very uniform particle size (hereinafter termed “mono-disperse”), since the more advantageous hydrodynamic properties of an exchanger bed made of monodisperse ion exchangers can achieve cost advantages in many applications. Monodisperse ion exchangers can be obtained by functionalizing monodisperse bead polymers.

One way of preparing monodisperse bead polymers is known as the seed/feed process. In this process, monodisperse polymer particles (“seed”) are swollen in the monomer, which is then polymerized. These seed/feed processes are described in EP-A 98,130 and EP-A 101,943, for example.

EP-A 826,704 discloses a seed/feed process in which micro-encapsulated crosslinked bead polymer is used as seed.

A problem with known cation exchangers is that they can tend to give undesirable leaching due to soluble polymers originally present or formed during use.

DE-A 19 852 667 therefore discloses a process for preparing monodisperse cation-exchanger gels, giving gels with higher stability and purity. A disadvantage of the process according to DE-A 19 852 667 is that it is what is known as a random seed/feed process, which uses a seed with a low level of crosslinking and in which the addition of the feed under non-polymerizing conditions gives a non-uniform distribution of length of the network grid in the bead polymer and therefore also in the cation exchanger. This reduces the oxidation resistance of the resins, for example, once they are used in desalination plants, for example.

Another problem with the known cation exchangers is that their mechanical and osmotic stability is not always sufficient. For example, cation-exchanger beads can break down during dilution after sulfonation due to the osmotic forces which arise. It is true for all applications of cation exchangers that the bead shape of the exchangers must be retained, and there must be no partial or indeed complete degradation of the exchangers or breakdown into fragments during use. During the purifying process, fragments and shards of bead polymer can pass into the solutions to be cleaned and themselves cause contamination of the same. In addition, the presence of damaged bead polymers is itself disadvantageous for the manner in which the cation exchangers used function-in column processes. Shards lead to an increased pressure loss in the column system and thus reduce the throughput through the column of the liquid to be purified.

Cation exchangers have a wide variety of different applications. For example, they are used in treating drinking water, in preparing ultra high-purity water (needed in microchip production for the computer industry), for separating glucose and fructose by chromatography, and as catalysts for various chemical reactions (e.g., in preparing bisphenol A from phenol and acetone). For most of these applications it is desirable for the cation exchangers to fulfil the tasks expected of them without discharging contamination into their environment, either deriving from their preparation or produced by polymer degradation during their use. The presence of contamination in water eluted from the cation exchanger is detectable in that the pH falls off and the conductivity and/or the content of organic carbon (TOC content) of the water become higher.

The object of the present invention is therefore to provide mono-disperse cation-exchanger gels first with high stability and purity and second also with more uniform distributions of network grid length and therefore with improved oxidation resistance when compared with the cation exchangers known from the prior art.

For the purposes of the present invention, purity primarily means that the cation exchangers do not leach. Leaching becomes apparent through a rise in the conductivity of the water treated with the ion exchanger.

### SUMMARY OF THE INVENTION

In achieving the object, the present invention provides a process for preparing monodisperse cation-exchanger gels with increased oxidation resistance and with high osmotic stability and purity comprising

(a) polymerizing monodisperse microencapsulated monomer droplets made from a monomer mixture (1) comprising from 90.5 to 97.99% by weight of styrene, from 2 to 7% by weight of divinylbenzene, and from 0.01 to 2.5% by weight of free-radical Generator in aqueous suspension to conversions of from 76 to 100%,

(b) adding a monomer mixture (2) made from 70.5 to 95.99% by weight of styrene, from 4 to 15% by weight of divinylbenzene, from 0 to 12% by weight of a third comonomer, and from 0.01 to 2.5% by weight of one or more free-radical generators to form a copolymer, wherein a portion of from 50 to 100% by weight of the monomer mixture (2) is added under polymerization conditions in which at least one free-radical generator from monomer mixture (2) is active, and

(c) functionalizing the reaction product from process step (b) by sulfonation.

### DETAILED DESCRIPTION OF THE INVENTION

In one preferred embodiment of the process of the invention, after process step (b), the polymerization conversion of the monomer mixtures (1) and (2) is increased in an intermediate step (b′) before the copolymer is finally functionalized by sulfonation.

To make sure that only monodisperse products are obtained the monomer mixture 2 is added by jetting, seed/feed or spraying the monomer mixture 2 into a liquid which is essentially immiscible with the monomer mixture. Such processes are known from U.S. Pat. No. 3,922,255, U.S. Pat. No. 4,444,961 and U.S. Pat. No. 4 427 794.

For the purposes of the present invention, the divinylbenzene used in process step (a) can be of commercially available quality, comprising ethylvinylbenzene along with the isomers of divinylbenzene. For the purposes of the present invention, the amount of pure divinylbenzene is from 2 to 7% by weight (preferably from 3 to 6% by weight), based on the monomer mixture (1).

For the purposes of the present invention, examples of free-radical generators in process step (a) are peroxy compounds, such as dibenzoyl peroxide, dilauroyl peroxide, bis(p-chlorobenzoyl) peroxide, dicyclohexyl peroxydicarbonate, tert-butyl peroctoate, 2,5-bis(2-ethylhexanoylperoxy)-2,5-dimethylhexane, or tert-amylperoxy-2-ethylhexane, or else azo compounds, such as 2,2′-azobis(isobutyronitrile) or 2,2′-azobis(2-methylisobutyronitrile). Aliphatic peroxyesters are also highly suitable.

Examples of aliphatic peroxyesters are those having the formula (I), (II), or (III)

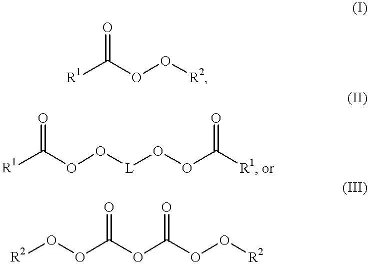

wherein

R¹ is an alkyl radical having from 2 to 20 carbon atoms or a cycloalkyl radical having up to 20 carbon atoms,

R² is a branched alkyl radical having from 4 to 12 carbon atoms, and

L is an alkylene radical having from 2 to 20 carbon atoms or a cyclo-alkylene radical having up to 20 carbon atoms.

According to the invention, examples of preferred aliphatic peroxy-esters of formula (I) are tert-butylperoxyacetate, tert-butyl peroxyisobutyrate, tert-butyl peroxypivalate, tert-butyl peroxyoctoate, tert-butyl peroxy-2-ethylhexanoate, tert-butyl peroxyneodecanoate, tert-amyl peroxyneodecanoate, tert-amyl peroxypivalate, tert-amyl peroxyoctoate, and tert-amyl peroxy-2-ethylhexanoate.

Examples of preferred aliphatic peroxyesters of formula (II) are 2,5-bis(2-ethylhexanoylperoxy)-2,5-dimethylhexane, 2,5-dipivaloyl-2,5-dimethylhexane, and 2,5-bis(2-neodecanoylperoxy)-2,5-dimethylhexane.

Examples of preferred aliphatic peroxyesters of formula (III) are di-tert-butyl peroxyazelate and di-tert-amyl peroxyazelate.

According to the invention, the amounts of the free-radical generators generally used in process step (a) are from 0.01 to 2.5% by weight (preferably from 0.1 to 1.5% by weight), based on monomer mixture (1). It is, of course, also possible for mixtures of the above-mentioned free-radical generators to be used, for example, mixtures of free-radical generators with different decomposition temperatures.

Possible materials for the microencapsulation of the monomer droplets in process step (a) are those known for this purpose, particularly polyesters, naturally occurring or synthetic polyamides, polyurethanes, or polyureas. A particularly suitable naturally occurring polyamide is gelatin, utilized in particular as coacervate or complex coacervate. For the purposes of the present invention, gelatin-containing complex coacervates are especially combinations of gelatin with synthetic polyelectrolytes. Suitable synthetic polyelectrolytes are copolymers incorporating units of, for example, maleic acid, acrylic acid, methacrylic acid, acrylamide, or methacrylamide. Gelatin-containing capsules may be hardened by conventional hardeners, such as formaldehyde or glutaric dialdehyde. The encapsulation of monomer droplets, for example by gelatin, by gelatin-containing coacervates, or by gelatin-containing complex coacervates, is described in detail in EP-A 46,535. The methods for encapsulation by synthetic polymers are known. An example of a highly suitable method is interfacial condensation, in which a reactive component dissolved in the monomer droplet (for example an isocyanate or an acid chloride) is reacted with a second reactive component dissolved in the aqueous phase (for example an amine). Micro-encapsulation by gelatin-containing complex coacervate is preferred.

The polymerization of the monodisperse microencapsulated droplets from monomer mixture (1) in process step (a) takes place in aqueous suspension at an elevated temperature of, for example, from 55 to 95° C. (preferably from 60 to 80° C.) to a conversion of from 76 to 100% by weight (preferably from 85 to 100% by weight). The ideal polymerization temperature in each case can be calculated by the skilled worker from the half-life times for the free-radical generators. The suspension is stirred during the polymerization. The stir speed here is not critical. It is possible to use low stirring speeds which are just adequate to maintain the droplets in suspension.

The ratio by weight of monomer mixture (1) to water is from 1:1 to 1:20, preferably from 1:2 to 1: 10.

To stabilize the microencapsulated monomer droplets in the aqueous phase, dispersing agents may be used. Dispersing agents suitable according to the invention are naturally occurring or synthetic water-soluble polymers, such as gelatin, starch, polyvinyl alcohol, polyvinylpyrrolidone, polyacrylic acid, polymethacrylic acid, or copolymers made of (meth)acrylic acid or of (meth)acrylates. Cellulose derivatives are also highly suitable, particularly cellulose esters and cellulose ethers, such as carboxymethylcellulose and hydroxyethylcellulose. The amount of the dispersing agents used is generally from 0.05 to 1% by weight, based on the aqueous phase, preferably from 0.1 to 0.5% by weight.

If desired, the polymerization in process step (a) may be carried out in the presence of a buffer system. Buffer systems preferred according to the invention establish a pH of from 12 to 3 (preferably from 10 to 4) for the aqueous phase at the start of the polymerization. Particularly highly suitable buffer systems comprise phosphate salts, acetate salts, citrate salts or borate salts.

It can be advantageous to use an inhibitor dissolved in the aqueous phase. Either inorganic or organic substances may be used as inhibitors. Examples of inorganic inhibitors are nitrogen compounds, such as hydroxylamine, hydrazine, sodium nitrite, and potassium nitrite. Examples of organic inhibitors are phenolic compounds, such as hydroquinone, hydroquinone monomethyl ether, resorcinol, pyrocatechol, tert-butyl pyrocatechol, and condensation products of phenols with aldehydes. Other organic inhibitors are nitrogen-containing compounds, such as diethyl-hydroxylamine and isopropylhydroxylamine. Resorcinol is preferred as inhibitor. The concentration of the inhibitor is from 5 to 1000 ppm (preferably from 10 to 500 ppm, particularly preferably from 20 to 250 ppm), based on the aqueous phase.

In one particular embodiment of process step (a) in the present invention, the aqueous suspension comprises dissolved acrylonitrile in the aqueous phase. The amount of acrylonitrile is from 1 to 10% by weight (preferably from 2 to 8% by weight), based on monomer mixture (1).

It has been found that high proportions of the acrylonitrile added to the aqueous phase becomes incorporated into the polymer made from the monomer mixture (1). In the process of the invention, the incorporation rate for the acrylonitrile is above 90% by weight, preferably above 95% by weight.

The particle size of the monodisperse microencapsulated monomer droplets in process step (a) is from 10 to 600 μm, preferably from 20 to 450 μm, particularly preferably from 100 to 400 μm. Conventional methods, such as screen analysis or image analysis, are suitable for determining the median particle size and the particle size distribution. The ratio calculated from the 90% value (Ø (90)) and the 10% value (Ø (10)) from the volume distribution give a measure of the breadth of the particle size distribution of the monomer droplets. The 90% value (Ø (90)) gives the diameter that is not exceeded by 90% of the particles. Correspondingly, 10% of the particles do not exceed the diameter of the 10% value (Ø (10)). For the purposes of the present invention, monodisperse particle size distributions imply Ø (90)/Ø (10)≦15, preferably Ø (90)/Ø (10)≦1.25.

The polymer suspension resulting from process step (a) may be further processed directly in process step (b). It is also possible for the polymer from process step (a) to be isolated, if desired, to be washed by and to be dried and placed in intermediate storage.

If the polymer obtained in process step (a) is isolated, it is suspended in an aqueous phase in process step (b), the ratio by weight of polymer to water being from 1:1 to 1:20. According to the invention, preference is given to a ratio by weight of from 1:1 to 1:10. The aqueous phase comprises a dispersion agent, and the nature and amount of the dispersion agent can be the same as those specified above under process step (a).

The monomer mixture (2) in process step (b) comprises from 4 to 15% by weight (preferably from 5 to 12% by weight) pure divinylbenzene. As described above under process step (a), technical divinylbenzene qualities can be used.

Examples of a third comonomer in monomer mixture (2) are esters of acrylic acid or methacrylic acid, such as methyl methacrylate, methyl acrylate, or ethyl acrylate, or else acrylonitrile or methacrylonitrile. Acrylo-nitrile is preferred. The amount of preferred comonomer is from 0 to 12% by weight (preferably from 2 to 10% by weight, particularly preferably from 4 to 8% by weight), based on the monomer mixture (2).

Free-radical generators that may be used in process step (b) are those described under process step (a). Aliphatic peroxyesters are also preferred in process step (b).

The weight ratio of polymer from process step (a) to monomer mixture (2) is from 1:0.5 to 1:10, preferably from 1:0.75 to 1:6. The manner of addition of the monomer mixture (2) to the polymer obtained in process step (a) is such that a first portion of from 0 to 50% by weight (preferably from 10 to 50% by weight, particularly preferably from 10 to 25%) is added under conditions under which none of the free-radical generators from monomer mixture (2) is active, generally at a temperature of from 0 to 50° C. (preferably from 10 to 40° C.).

The addition of the second portion of the monomer mixture (2) that gives 100% when added to the first portion takes place over a relatively long period, e.g., over from 10 to 1000 min (preferably over from 30 to 600 min) under conditions under which at least one free-radical generator from monomer mixture (2) is active. This addition may take place at a constant rate or at a rate which changes over time. The composition of the monomer mixture (2) may be altered within the prescribed limits during the addition. It is also possible for the first portion and the second portion to differ from one another in their composition in relation to content of divinylbenzene, comonomer, or free-radical generator.

During the addition, the temperature selected is such that at least one of the free-radical generators present in the system is active. The temperatures used are generally from 60 to 130° C., preferably from 60 to 95° C. Once process step (b) has concluded, the polymerization conversion of the monomer mixtures (1) and (2) is generally from 60 to 95% by weight.

The monomer mixture (2) of the present invention may be added in pure form. In one particular embodiment, the monomer mixture (2) or some of this mixture is added in the form of an emulsion in water. This emulsion in water may be prepared simply by mixing the monomer mixture with water, using an emulsifier, for example with the aid of a high-speed stirrer, of a rotor-stator mixer, or of a liquid spray jet. The weight ratio of monomer mixture to water here is preferably from 1:0.75 to 1:3. The emulsifiers may be ionic or nonionic in nature. Examples of very suitable emulsifiers are ethoxylated nonylphenols having from 2 to 30 ethylene oxide units or else the sodium salt of isooctyl sulfosuccinate.

In the intermediate step (b′) to be introduced where appropriate, as in the preferred embodiment of the present invention after process step (b), the polymerization mixture is held at a temperature of from 60 to 140° C. (preferably from 90 to 130° C.) for a period from 1 to 8 hours once addition of the monomer mixture (2) has ended, in order to obtain full polymerization conversion of the monomer mixtures (1) and (2), this being advantageous where appropriate. To achieve high polymerization conversions it is useful for the temperature to rise during the completion of polymerization. Process step (b′) raises the polymerization conversion of the monomer mixtures (1) and (2) to 90 to 100% by weight, preferably to 95 to 100% by weight.

After the polymerization, the resultant copolymer can be isolated by the usual methods, e.g. by filtration or decanting, and dried after one or more washes with deionized water, where appropriate, and, if desired, screened.

The conversion of the reaction product from process step (b) or of the reaction product from the intermediate step (b′) introduced after process step (b) to give the cation exchanger in process step (c) takes place by sulfonation. For the purposes of the present invention, suitable sulfonating agents are sulfuric acid, sulfur trioxide, and chlorosulfonic acid. Preference is given to sulfuric acid with a concentration from 90 to 100% by weight, particularly preferably from 96 to 99% by weight. The temperature during the sulfonation is generally from 50 to 200° C., preferably from 90 to 150° C., particularly preferably from 95 to 130° C. It has been found that the copolymers of the invention can be sulfonated without adding swelling agents (e.g., chlorobenzene or dichloroethane), giving homogeneous sulfonation products.

During the sulfonation, the reaction mixture is stirred. A variety of stirrer types may be used here, for example, blade stirrers, anchor stirrers, gate stirrers, or turbine agitators. Radial-flow twin-turbine agitators have been found to be particularly suitable.

In one particular embodiment of the present invention, the sulfonation takes place by what is known as the semibatch process. In this method, the copolymer is metered into the temperature-controlled sulfuric acid. Feeding in portions is particularly advantageous in this method.

After the sulfonation, the reaction mixture made from sulfonation product and residual acid is cooled to room temperature and diluted first with sulfuric acids of decreasing concentration and then with water.

If desired, the cation exchanger obtained according to the invention in the H form may be treated with deionized water at temperatures from 70 to 145° C. (preferably from 105 to 130° C.) for purification.

For many applications it is useful to convert the cation exchanger from the acid form into the sodium form. This conversion takes place using sodium hydroxide solution whose concentration is from 10 to 60% by weight (preferably from 40 to 50% by weight). The conversion may be carried out at a temperature from 0 to 120° C., for example, at room temperature. During this process step, the heat of reaction produced can be used to adjust the temperature.

After the conversion, the cation exchangers may be treated with deionized water or with aqueous salt solutions, for example, with sodium chloride solutions or with sodium sulfate solutions, for further purification. It has been found here that treatment at from 70 to 150° C. (preferably from 120 to 135° C.) is particularly effective and does not bring about any reduction in the capacity of the cation exchanger.

The cation exchangers obtained by the process of the invention have high monodispersity. The particle size distribution of the cation exchangers is an enlarged version of the particle size distribution of the microencapsulated monomer droplets. It is surprising that despite the microencapsulation of the monomer droplets, the monomer mixture added in process step (b) penetrates fully and uniformly into the polymer particles formed in process step (a).

The cation exchangers obtained have particularly high stability and purity. Even after prolonged use and multiple regeneration, they have extremely few defects in the ion-exchanger beads and exhibit less leaching of the exchanger when compared with products of the prior art.

Since the cation exchangers of the present invention have markedly higher stability and purity when compared with the prior art, particularly increased oxidation resistance, they are particularly suitable for treating drinking water, for preparing ultrahigh-purity water, for separating sugars by chromatography, for example separating glucose from fructose, and also as catalysts for chemical reactions and in condensation reactions, particularly in the synthesis of bisphenol A from phenol and acetone. The cation exchangers according to the invention are furthermore suitable

for the removal of cations, colorant particles or organic components from aqueous or organic solutions and condensates, such as, for example, process or turbine condensates,

for the softening of aqueous or organic solutions and condensates, such as, for example process or turbine condensates in neutral exchange,

for the purification and treatment of water in the chemical industry, the electronics industry and from power stations,

for the demineralization of aqueous solutions and/or condensates, such as, for example, process or turbine condensates,

in combination with heterodisperse or monodisperse, gelatinous and/or macroporous anion exchangers, for the demineralization of aqueous solutions and/or condensates, such as, for example, process or turbine condensates,

for the decolorization and desalination of whey, gelatin solutions, fruit juice, fruit must and aqueous solutions of sugars.

Consequently, the invention likewise relates to A process for the removal of cations, colorant particles or organic components from aqueous or organic solutions and condensates, such as, for example, process or turbine condensates, using the cation exchangers according to the invention.

A process for the softening of aqueous or organic solutions and condensates, such as, for example, process or turbine condensates, in neutral exchange using the cation exchangers according to the invention.

A process for the purification and treatment of water in the chemical industry, the electronics industry and from power stations using the cation exchanger according to the invention.

A process for the demineralization of aqueous solutions and/or condensates, such as, for example, process or turbine condensates, using the cation exchangers according to the invention in combination with heterodisperse or monodisperse, gelatinous and/or macoporous anion exchangers.

A process for the decolorization and desalination of whey, gelatin solutions, fruit juices, fruit musts and aqueous solutions of sugars in the sugar, starch or pharmaceuticals industries or dairies using the cation exchangers according to the invention.

### EXAMPLES

### Example 1 (inventive)

a) Preparation of a copolymer

1260 g of an aqueous mixture comprising 630 g of monodisperse microencapsulated monomer droplets with a median particle size of 330 μm and with a Ø (90)/Ø (10) value of 1.03, composed of 94.53% by weight of styrene, 4.98% by weight of divinylbenzene, and 0.50% by weight of tert-butyl peroxy-2-ethylhexanoate were mixed in a 4 liter glass reactor with an aqueous solution made from 2.13 g of gelatin, 3.52 g of sodium hydrogen phosphate dodecahydrate, and 175 mg of resorcinolin 1400 ml of deionized water. The mixture was polymerized, with stirring (stirrer speed 200 rpm) for 8 h at 75° C. and then for 2 h at 95° C. The mixture was washed using a 32 μm screen and dried to give 622 g of a bead polymer with a smooth surface. The polymers were visually transparent.

600.0 g of a monodisperse microencapsulated polymer prepared by the above process were mixed with an aqueous solution of 3.58 g of boric acid and 0.98 g of sodium hydroxide in 1100.0 g of deionized water. This mixture was treated, with stirring (stirrer speed 220 rpm), with a mixture made from 93.4 g of styrene, 17.0 g of 80.6% strength divinylbenzene, 9.6 g of acrylonitrile, 0.43 g of tert-butyl peroxy-2-ethylhexanoate, and 0.30 g of tert-butyl peroxybenzoate (addition rate 4.0 g/min). After steeping for 1 h, the mixture was mixed with an aqueous solution of 2.44 g of methylhydroxyethylcellulose (Walocel MT 400®) in 122 g of deionized water. The mixture was polymerized for 10 h at 63° C. As soon as the polymerization temperature of 63° C. had been reached, a monomer mixture made from 373.7 g of styrene, 67.9 g of 80.6% strength divinylbenzene, 38.4 g of acrylonitrile, 1.73 g of tert-butyl peroxy-2-ethylhexanoate, and 1.20 g of tert-butyl peroxybenzoate was added dropwise over a period of 5 h at a constant rate. The mixture was then held for 3 h at 130° C. The mixture was washed using a 32 μm screen and dried to give 1186 g of a bead polymer with a smooth surface. The polymers were visually transparent; the median particle size was 410 μm, and the Ø (90)/Ø (10) value was 1.06.

b) Preparation of a cation exchanger

In a 2 liter four-necked flask, 1800 ml of 97.32% strength by weight sulfuric acid were heated to 100° C. A total of 400 g of dry polymer from Example 1a were introduced, with stirring, in 10 portions over 4 h. Stirring was then continued for a further 6 h at 120° C. After cooling, the suspension was transferred to a glass column. Sulfuric acids of decreasing concentrations, beginning at 90% by weight, and finally pure water, were allowed to filter downwards through the column. This gave 1792 ml of cation exchanger in the H form.

### Example 2 (inventive)

a) Preparation of a copolymer

1060 g of an aqueous mixture comprising 530 g of monodisperse microencapsulated monomer droplets with a median particle size of 320 μm and with a Ø (90)/Ø (10) value of 1.03, composed of 94.53% by weight of styrene, 4.98% by weight of divinylbenzene, and 0.50% by weight of tert-butyl peroxy-2-ethylhexanoate were mixed in a 4 liter glass reactor with an aqueous solution made from 1.79 g of gelatin, 2.97 g of sodium hydrogen phosphate dodecahydrate. and 148 mg of resorcinol in 1177 ml of deionized water. The mixture was polymerized with stirring (stirrer speed 200 rpm) for 8 h at 75° C. and then for 2 h at 95° C. The mixture was washed using a 32 μm screen and dried to give 524 g of a bead polymer with a smooth surface. The polymers were visually transparent.

521.7 g of a monodisperse microencapsulated polymer prepared by the above process were mixed with an aqueous solution of 3.58 g of boric acid and 0.98 g of sodium hydroxide in 522 g of deionized water. This mixture was treated, with stirring (stirrer speed 220 rpm), with a mixture made from 135.2 of styrene, 22.4 g 80.6% strength divinylbenzene, 12.0 g of acrylonitrile, 0.61 g of tert-butyl peroxy-2-ethylhexanoate, and 0.42 g of tert-butyl peroxybenzoate (addition rate 4.0 g/min). After steeping for 1 h, the mixture was mixed with an aqueous solution of 2.88 g of methyl-hydroxyethylcellulose (Walocel MT 400®) in 144 g of deionized water. The mixture was polymerized for 10 h at 63° C. As soon as the polymerization temperature of 63° C. had been reached, a monomer mixture made from 405.5 g of styrene, 67.3 g of 80.6% strength divinylbenzene, 36.0 g of acrylonitrile, 1.83 g of tert-butyl peroxy-2-ethylhexanoate, and 1.27 g of tert-butyl peroxybenzoate in the form of an emulsion in deionized water was added dropwise over a period of 5 h at a constant rate. With the aid of a rotor-stator mixer, the monomer mixture was emulsified in a solution made from 2.57 g of ethoxylated nonylphenol (Arkopal N 060®) and 1.71 g of the sodium salt of isooctyl sulfosuccinate (75% by weight in ethanol) in 780 g of deionized water (size of emulsified monomer droplets from 1 to 2 μm). The mixture was then held for 3 h at 130° C. The mixture was washed using a 32 μm screen and dried to give 1192 g of a bead polymer with a smooth surface. The polymers were visually transparent; the median particle size was 420 μm, and the Ø (90)/Ø (10) value was 1.04.

b) Preparation of a cation exchanger

In a 2 liter four-necked flask, 1800 ml of 97.32% strength by weight sulfuric acid were heated to 100° C. A total of 400 g of dry polymer from Example 2a were introduced, with stirring, in 10 portions over 4 h. Stirring was then continued for a further 6 h at 120° C. After cooling, the suspension was transferred to a glass column. Sulfuric acids of decreasing concentrations, beginning at 90% by weight, and finally pure water, were allowed to filter downwards through the column. This gave 1790 ml of cation exchanger in the H form.

### Example 3 (inventive)

a) Preparation of a copolymer

1040.2 g of an aqueous mixture comprising 520.1 g of monodisperse microencapsulated monomer droplets with a median particle size of 340 μm and with a Ø (90)/Ø (10) value of 1.03, composed of 96.52% by weight of styrene, 2.99% by weight of divinylbenzene, and 0.50% by weight of tert-butyl peroxy-2-ethylhexanoate were mixed in a 4 liter glass reactor with an aqueous solution made from 2.56 g of gelatin, 4.22 g of sodium hydrogen phosphate dodecahydrate, and 212 mg of resorcinol in 980.4 ml of deionized water. 45.6 g of acrylonitrile were added to this mixture, with stirring (stirrer speed 200 rpm). The mixture was polymerized for 8 h at 75° C. and then for 2 h at 95° C. The mixture was washed using a 32 μm screen and dried to give 1036 g of a bead polymer with a smooth surface. The polymers were visually transparent. The polymer contained 3.8% by weight of acrylonitrile (elemental analysis).

521.7 g of a monodisperse microencapsulated polymer prepared by the above process were mixed with an aqueous solution of 3.58 g of boric acid and 0.98 g of sodium hydroxide in 1100.0 g of deionized water. This mixture was treated, with stirring (stirrer speed 220 rpm) with a mixture made from 109.4 g of styrene, 20.7 g of 80.6% strength divinylbenzene, 5.6 g of acrylonitrile, 0.49 g of tert-butyl peroxy-2-ethylhexanoate, and 0.34 g of tert-butyl peroxybenzoate (addition rate 4.0 g/min). After steeping for 1 h, the mixture was mixed with an aqueous solution of 2.44 g of methyl-hydroxyethylcellulose (Walocel MT 400®) in 122 g of deionized water. The mixture was polymerized for 10 h at 63° C. As soon as the polymerization temperature of 63° C. had been reached, a monomer mixture made from 437.4 g of styrene, 82.6 g of 80.6% strength divinylbenzene, 22.6 g of acrylonitrile, 1.95 g of tert-butyl peroxy-2-ethylhexanoate, and 1.36 g of tert-butyl peroxybenzoate was added dropwise over a period of 5 h at a constant rate. The mixture was then held for 3 h at 130° C. The mixture was washed using a 32 μm screen and dried to give 1185 g of a bead polymer with a smooth surface. The polymers were visually transparent, the median particle size was 420 μm, and the Ø (90)/Ø (10) value was 1.06.

b) Preparation of a cation exchanger

In a 2 liter four-necked flask, 1800 ml of 97.32% strength by weight sulfuric acid were heated to 100° C. A total of 400 g of dry polymer from Example 3a were introduced, with stirring, in 10 portions over 4 h. Stirring was then continued for a further 6 h at 120° C. After cooling, the suspension was transferred to a glass column. Sulfuric acids of decreasing concentrations, beginning at 90% by weight, and finally pure water, were allowed to filter downwards through the column. This gave 1794 ml of cation exchanger in the H form.

What is claimed is:

1. A process for preparing monodisperse cation-exchanger gels with increased oxidation resistance and with high osmotic stability and purity comprising
(a) polymerizing monodisperse microencapsulated monomer droplets made from a monomer mixture (1) comprising from 90.5 to 97.99% by weight of styrene, from 2 to 7% by weight of divinylbenzene, and from 0.01 to 2.5% by weight of free-radical generator in aqueous suspension to conversions of from 76 to 100%,
(b) adding a monomer mixture (2) made from 70.5 to 95.99% by weight of styrene, from 4 to 15% by weight of divinylbenzene, from 0 to 12% by weight of a third comonomer, and from 0.01 to 2.5% by weight of one or more free-radical generators to form a copolymer, wherein a portion of from 50 to 100% by weight of the monomer mixture (2) is added under polymerization conditions in which at least one free-radical generator from monomer mixture (2) is active, and
(c) functionalizing the reaction product from process step (b) by sulfonation.

2. A process according to claim 1 additionally comprising, after process step (b) and before step (c), increasing the polymerization conversion of the monomer mixtures (1) and (2).

3. A process according to claim 1 wherein the aqueous suspension in step (a) additionally comprises from 1 to 10% by weight of acrylonitrile, based on monomer mixture (1).

4. A process according to claim 1 wherein the monomer mixture (2) is added to the polymer obtained from step (a) in such a way that a portion of from 60 to 90% by weight is added under conditions under which at least one of the free-radical generators from monomer mixture (2) is active.

5. A process according to claim 1 wherein addition of the portion of the monomer mixture (2) that is added under polymerization conditions takes place over a period of from 10 to 1000 min.

6. A process according to claim 1 wherein in step (b), at least a portion of the monomer mixture (2) is added as an emulsion in water.

7. A process according to claim 1 wherein the free-radical generator used in monomer mixture (1) and/or (2) comprises an aliphatic peroxyester of the formulas 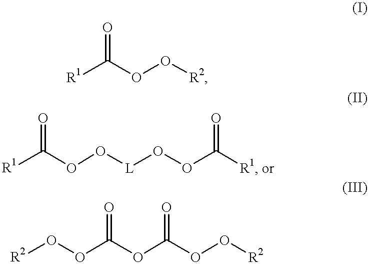
wherein
R¹ is an alkyl radical having from 2 to 20 carbon atoms or a cycloalkyl radical having up to 20 carbon atoms,
R² is a branched alkyl radical having from 4 to 12 carbon atoms, and
L is an alkylene radical having from 2 to 20 carbon atoms or a cyclo-alkylene radical having up to 20 carbon atoms.

8. A process according to claim 1 wherein the sulfonation takes place without swelling agents.

9. A cation exchanger in the H form obtained according to the process of claim 1.

10. A cation exchanger in the sodium form obtained by converting a cation exchanger according to claim 9 using sodium hydroxide solution having a concentration of from 10 to 60% by weight.

11. A method comprising treating drinking water, preparing ultra high-purity water, or separating sugars by chromatography with a cation exchanger according to claim 9.

12. A method comprising treating drinking water, preparing ultra high-purity water, or separating sugars by chromatography with a cation exchanger according to claim 10.

13. A method comprising catalyzing a chemical reaction with a cation exchanger according to claim 9.

14. A method comprising catalyzing a chemical reaction with a cation exchanger according to claim 10.

15. A method for synthesizing bisphenol A from phenol and acetone in the presence of a cation exchanger according to claim 9.

16. A method for synthesizing bisphenol A from phenol and acetone in the presence of a cation exchanger according to claim 10.
